(19) United States
(12) Patent Application Publication
(10) Pub. No.: US 2014/0057663 A1
(43) Pub. Date: Feb. 27, 2014

(54) PORTABLE DEVICE

(71) Applicants: Wei-Ting Liu, Hacienda Heights, CA (US); Wei-Hua Lu, Taipei (TW)

(72) Inventors: Wei-Ting Liu, Hacienda Heights, CA (US); Wei-Hua Lu, Taipei (TW)

(21) Appl. No.: 13/594,865

(22) Filed: Aug. 26, 2012

(51) Int. Cl. H04W 4/02; H04W 88/02

(52) U.S. Cl. 455/456.4; 455/550.1; 455/572

(57) ABSTRACT

A portable device comprises a memory and a wireless signal receiver. The memory is used for storing a first internal setting and a second internal setting, wherein the first internal setting is capable of being determined by users, and the second internal setting is reserved and unchangeable. The wireless signal receiver is used for receiving a predetermined setting signal corresponding to the second internal setting. The portable device switches from the first state into the second state according to the second internal setting after the wireless signal receiver receives the predetermined setting signal.

### BACKGROUND OF THE INVENTION

1. Field of the Invention

The invention relates to a portable device, and more particularly, to a portable device capable of automatically changing the internal setting configuration when the user arriving a specific environment.

2. Description of the Prior Art

With the rapid progression of technology, more and more people use the portable devices, such as PDA, smart phone, cell phone or tablet PC, in their daily life. However, the sound or ringtone of the portable devices is sometimes another kind of noise in some occasions. For example, the ringtone from cell phone is disgusted in the museum or theater, and we can always find some people negligently forget to turn off their cell phone in such occasions. In some circumstances, such as on the airplane or in the hospital, this kind of negligence may not only cause the displeasure from other people but also have safety issue.

The internal configuration of present portable devices, such as ringtone or vibration, can be mostly changed by the user via the user interface of the portable device. Besides, some calendar software can also change the configuration of the portable devices by scheduling the program in the devices in advance. Nevertheless, the present operation of the portable devices needs user's input to change the configuration and cannot avoid the negligence or obliviousness of some users.

### SUMMARY OF THE INVENTION

It is therefore a primary objective of the claimed invention to provide a portable device. The claimed invention can automatically change the internal setting configuration of the portable device according to the location of the user.

An embodiment of the invention discloses a portable device comprising a memory and a wireless signal receiver. The memory is used for storing a first internal setting and a second internal setting. The first internal setting is capable of being determined by users, and the second internal setting is reserved and unchangeable. The wireless signal receiver is used for receiving a predetermined setting signal corresponding to the second internal setting. The portable device switches from the first state into the second state according to the second internal setting after the wireless signal receiver receives the predetermined setting signal.

Another embodiment of the invention discloses a portable device comprising a wireless signal receiver, an internal memory and a battery. The wireless signal receiver is used for receiving a setting signal provided by a communication base, the internal memory is used for storing an internal setting of the portable device, and the battery is used for providing power to the portable device. The setting signal is related to a property of a location where the communication base is located. The portable device switches from the first state into the second state according to the setting signal after the wireless signal receiver receives the setting signal.

A further embodiment of the invention discloses a portable device comprising a wireless signal receiver, an internal memory and a battery. The wireless signal receiver is used for receiving a first setting signal when the portable device is entering a designated region, the internal memory is used for storing an internal setting of the portable device, and the battery is used for providing power to the portable device. The portable device switches from the first state into the second state when the wireless signal receiver receives the first setting signal, and the portable device switches from the second state back to the first state when the portable device is leaving the designated region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the first embodiment of the present invention.

FIG. 2 is a schematic diagram of the second embodiment of the present invention.

FIG. 3 is a schematic diagram of the third embodiment of the present invention.

FIG. 4 is a schematic diagram of the fourth embodiment of the present invention.

FIG. 5 is a schematic diagram of the fifth embodiment of the present invention.

### DETAILED DESCRIPTION

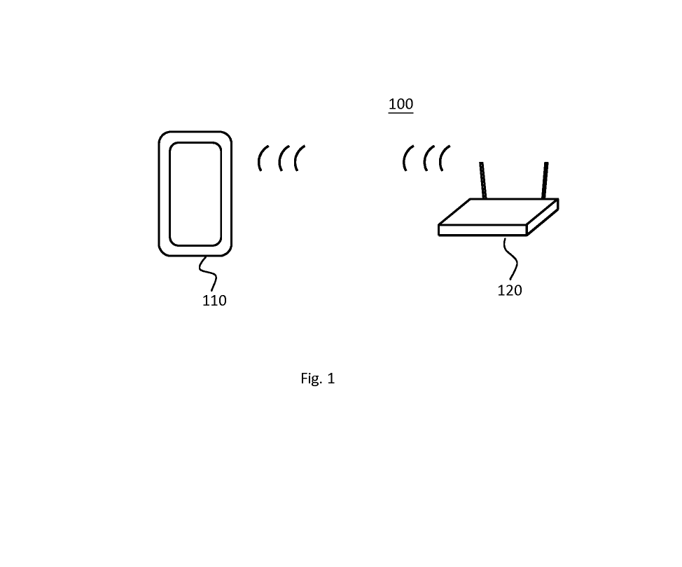

Please refer to FIG. 1, which shows the first embodiment of the present invention. In FIG. 1, the mobile communication system 100 includes a mobile device 110 and a wireless access point 120, and the mobile device 110 and the wireless access point 120 communicate each other via a wireless communication standard, such as infrared, Wi-Fi, Bluetooth and so on. Every wireless access point or router is manufactured with a unique media access control (MAC) address, and the wireless access point 120 of this embodiment also has its own unique MAC address. When the mobile device 110 communicates with the wireless access point 120, the mobile device 110 can read the MAC address of the wireless access point 120 and identify the location of the wireless access point 120. The MAC address of the wireless access point 120 is one kind of location information, and the mobile device 110 can further compare the location information with a database to identify its location. In the database, some predetermined locations are categorized to, for example, normal area, silent area, no-flash area, no-camera area, machine-off area and so on, and the internal configuration of the mobile device 110 can be automatically changed according to the comparison result. For example, if the user of the mobile device 110 enters a library, the mobile device 110 will receive the location information via the communication with the wireless access point 120 located in the library to identify the mobile device is in a silent area, and then the mobile device 110 will be automatically switched to a silent mode. For another example, if the user of the mobile device 110 moves to a museum, the mobile device 110 will receive the location information via the communication with another wireless access point 120 located in the museum to identify the mobile device is in a silent, no-camera and no-flash area, and then the mobile device 110 will be automatically switched to a silent, no-camera and no-flash mode.

In the present invention, the location categorization can be stored in the internal memory of the mobile device 110 or be stored in a remote database. Whenever the mobile device 110 obtains the location information, the mobile device 110 can access the internal memory or the remote database to identify it.

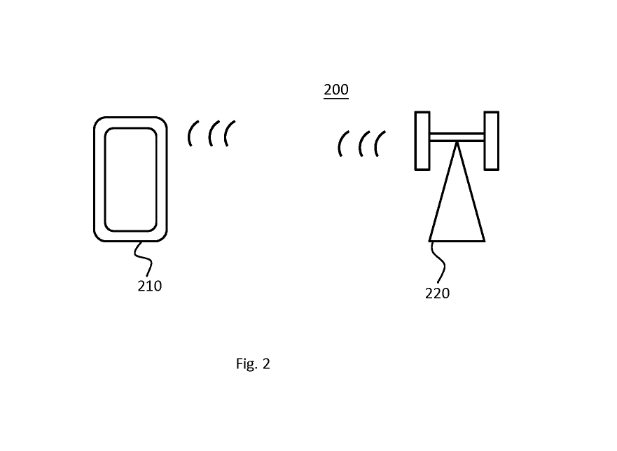

Please refer to FIG. 2, which is the second embodiment of the present invention. In FIG. 2, the mobile communication system 200 includes a mobile phone 210 and a communication base 220. In one example of this embodiment, the communication base 220 can be an access point (AP) or an internet router which communicates with the mobile phone 210 via infrared, Wi-Fi, Bluetooth and so on. In other example of this embodiment, the communication base 220 can be a mobile phone base station which communicates with the mobile phone 210 via the mobile phone air interface standard. The mobile phone air interface standard is, for example, Global System for Mobile Communications (GSM), Code Division Multiple Access (CDMA), Long Term Evolution (LTE), or other industry standard adopted by international standards bodies, such as the Telecommunications Industry Association (TIA), the European Telecommunication Standard Institute (ETSI) or Japan's Association of Radio Industries and Businesses (ARIB). The mobile phone 210 has two internal setting states, in which the first internal setting state is defined by the user and the second internal setting state is configured by the manufacture and cannot be changed by the user. The first and second internal setting states are related to the functions of the mobile phone 210, such as volume, camera or flash functions. The mobile phone 210 comprises a battery for providing power to the mobile phone 210, a memory for storing the first and second internal setting, and a wireless signal receiver for receiving a predetermined setting signal. The predetermined setting signal is provided by the communication base 220. When the mobile phone 210 receives the predetermined setting signal from the communication base 220, which means the user is in a predefined environment, the mobile phone 210 will switch from the first internal setting state to the second internal setting state. The switching process can be automatically happened without user's input, or can switch after user's confirmation.

For example, the communication base 220 is established near a hospital, and for safety reason, when a user enters the hospital area, the mobile phone 210 will obtain the setting signal from the communication base 220. After receiving the setting signal, the mobile phone 210 is identified locating in the hospital area and will automatically switch to the second internal setting state, which turning off all wireless communication. In the present invention, when the user leaves the hospital area, the mobile phone 210 will switch back to the first internal setting state.

In another example of the present invention, the first and second internal setting can be both defined by the user

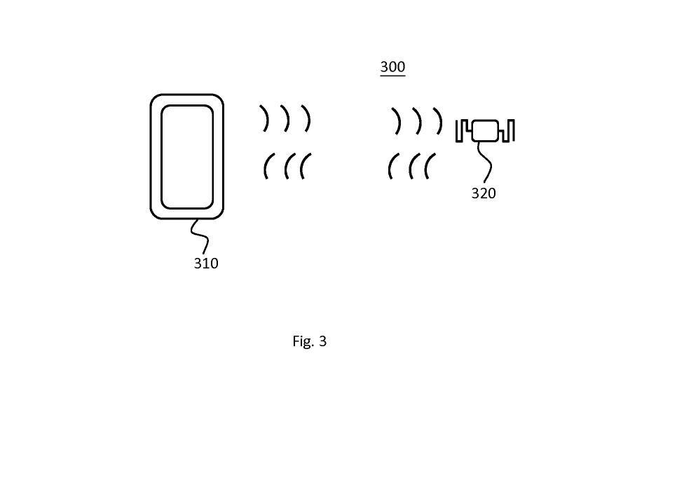

Please refer to FIG. 3, which is the third embodiment of the present invention. The mobile communication system 300 includes a mobile device 310 and a passive location circuitry 320. The mobile device 310 sends out a radio signal to trigger the passive location circuitry 320, such as the passive radio-frequency identification (RFID) tag or the passive near field communication (NFC) tag, and the passive location circuitry 320 can receive the radio signal from the mobile device 310 and send data back to the mobile device 310. The data sent by the passive location circuitry 320 includes predetermined location information of the passive location circuitry 320. Since the communication between the mobile device 310 and the passive location circuitry 320 includes the location information of the passive location circuitry 320, the mobile device 310 can switch from a first state to a second state according to the predetermined location information. For example, the passive location circuitry 320 is established on the entrance of a hospital, and for safety reason, when a user enters the hospital area, the mobile device 310 will obtain the location information from the passive location circuitry 320. After receiving the location information, the mobile device 310 will switch to the second internal setting state to turn off all wireless communication. In the present invention, the first internal setting is defined by the user, and the second internal setting can be defined by the user or configured by the manufacturer. The first and second internal settings are store in the internal memory of the mobile device 310.

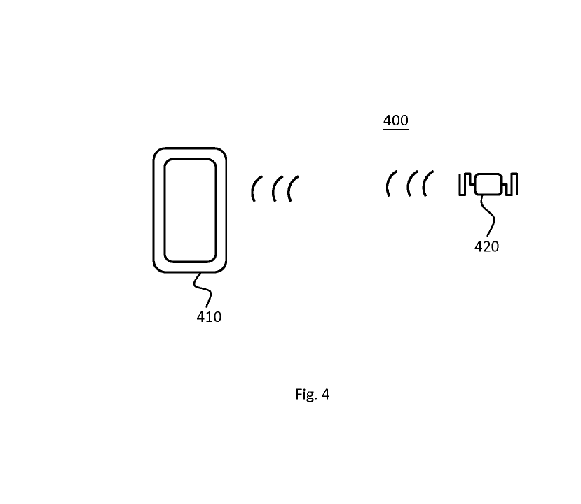

Please refer to FIG. 4, which is the fourth embodiment of the present invention. The mobile communication system 400 includes a mobile device 410 and an active location indicator 420. The active location indicator 420 can send out the radio signal and the radio signal includes the location information. For example, the active radio-frequency identification (RFID) tag or the active near field communication (NFC) tag can include its location information in the data communication to indicate a designated region. Since the communication between the mobile device 410 and the active location indicator 420 includes the location information of the active location indicator 420, the mobile device 410 can switch from a first state to a second state according to the predetermined location information when the user enters the designated region.

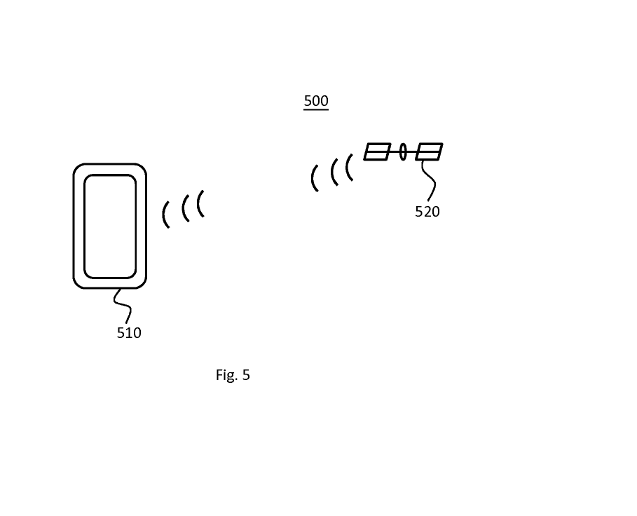

Please refer to FIG. 5, which is the fifth embodiment of the present invention. The mobile communication system 500 includes a mobile device 510 and a global positioning system (GPS) satellite 520. The conventional mobile device can receive GPS signals and position the mobile device on the map after computing the GPS signals. The mobile device 510 in the present invention can further compare the location information from the GPS satellite 520 with a database to identify its location categorization. In the database, some predetermined locations are categorized to, for example, normal area, silent area, no-flash area, no-camera area, machine-off area and so on, and the internal configuration of the mobile device 510 can be automatically changed according to the comparison result. For example, when the mobile device 510 receives the location information from the GPS satellite 520 and compares the location information with the database to identify its location categorization, the mobile device 510 is identified locating in the hospital area and will be automatically switched to an “Airplane Mode” to turn off all wireless communication.

In the present invention, the location categorization can be stored in the internal memory of the mobile device 510 or be stored in a remote database. Whenever the mobile device 510 obtains the location information, the mobile device 510 can access the internal memory or the remote database to identify it.

Those skilled in the art will readily observe that numerous modifications and alterations of the device and method may be made while retaining the teachings of the invention.

What is claimed is:

1. A portable device, having a first state, the portable device comprising:
a memory for storing a first internal setting corresponding to the first state and a second internal setting corresponding to a second state, the first internal setting is capable of being determined by users, and the second internal setting is reserved; and
a wireless signal receiver, for receiving a first predetermined setting signal corresponding to the second internal setting;
wherein the portable device switches from the first state into the second state according to the second internal setting after the wireless signal receiver receives the first predetermined setting signal.

2. The portable device of claim 1, wherein the portable device switches from the first state into the second state automatically after the wireless signal receiver receives the first predetermined setting signal.

3. The portable device of claim 1, wherein the portable device switches from the second state back to the first state when the wireless signal receiver fails to receive the first predetermined setting signal.

4. The portable device of claim 1, wherein the portable device switches from the second state back to the first state when the wireless signal receiver receives a second predetermined setting signal.

5. The portable device of claim 1, wherein the first predetermined setting signal is provided by a communication base.

6. The portable device of claim 5, wherein the communication base is an access point (AP), an internet router, an NFC (near field communication) tag, or a mobile phone base station.

7. The portable device of claim 5, wherein the first predetermined setting signal is related to a property of a location where the communication base is located.

8. A portable device, having a first state, the portable device comprising:
a wireless signal receiver for receiving a first setting signal provided by a communication base;
an internal memory for storing an internal setting of the portable device; and
a battery, for providing power to the portable device;
wherein the first setting signal is related to a property of a location where the communication base is located;
wherein the portable device switches from the first state into a second state according to the first setting signal after the wireless signal receiver receives the first setting signal.

9. The portable device of claim 8, wherein the portable device switches from the first state into the second state automatically after the wireless signal receiver receives the first setting signal.

10. The portable device of claim 8, wherein the portable device switches from the second state back to the first state when the wireless signal receiver fails to receive the first setting signal.

11. The portable device of claim 8, wherein the portable device switches from the second state back to the first state when the wireless signal receiver receives a second setting signal.

12. The portable device of claim 8, wherein the internal memory stores a first internal setting and a second internal setting, the first internal setting is capable of being determined by users and the second internal setting is capable of being changed according to the first setting signal provided by the communication base.

13. The portable device of claim 8, wherein the communication base is an access point (AP), an internet router, an NFC (near field communication) tag, or a mobile phone base station.

14. The portable device of claim 8, wherein the first setting signal is related to a property of a location where the communication base is located.

15. A portable device, having a first state, comprising:
a wireless signal receiver, for receiving a first setting signal when the portable device is entering a designated region;
an internal memory for storing an internal setting of the portable device; and
a battery, for providing power to the portable device;
wherein the portable device switches from the first state into a second state when the wireless signal receiver receives the first setting signal, and switches from the second state back to the first state when the portable device is leaving the designated region.

16. The portable device of claim 15, wherein the wireless signal receiver receives a second setting signal when the portable device is leaving the designated region, and the portable device switches from the second state back to the first state according to the second setting signal.

17. The portable device of claim 15, wherein the portable device switches from the first state into the second state automatically when the wireless signal receiver receives the first setting signal.

18. The portable device of claim 15, wherein the internal memory stores a first internal setting and a second internal setting, the first internal setting is capable of being determined by users and the second internal setting is reserved and unchangeable.

19. The portable device of claim 15, wherein the internal memory stores a first internal setting and a second internal setting, the first internal setting is capable of being determined by users and the second internal setting is capable of being changed according to the first setting signal.

20. The portable device of claim 15, wherein the first setting signal is provided by a communication base.

21. The portable device of claim 20, wherein the communication base is an access point (AP), an internet router, an NFC (near field communication) tag, or a mobile phone base station.

22. The portable device of claim 21, wherein the first setting signal is related to a property of a location where the communication base is located.
